(19) United States
(12) Patent Application Publication
(10) Pub. No.: US 2022/0001831 A1
(43) Pub. Date: Jan. 6, 2022

(54) SAFETY BELT AND METHOD FOR PRODUCING A SAFETY BELT

(71) Applicant: ZF AUTOMOTIVE GERMANY GMBH, Alfdorf (DE)

(72) Inventors: Martina RAUSCH, Remshalden (DE); Anna-Lena WEBER GEB. PROTT, Geldersheim (DE); András TÓTH, Gschwend (DE)

(21) Appl. No.: 17/280,900

(22) PCT Filed: Sep. 27, 2019
(86) PCT No.: PCT/EP2019/076171

§ 371 Date: Mar. 28, 2021

(30) Foreign Application Priority Data
Oct. 1, 2018 (DE) 10 2018 124 239.5

(51) Int. Cl. B60R 22/12; D03D 1/00; D03D 3/02; D03D 15/283; B32B 5/02; B32B 5/26; B32B 7/12; B32B 5/06; H05B 3/34; H05B 3/14; H05B 3/36

(52) U.S. Cl. CPC B60R 22/12; H05B 2203/016; D03D 3/02; D03D 15/283; B32B 5/024; B32B 5/022; B32B 5/262; B32B 5/265; B32B 7/12; B32B 5/073; H05B 3/342; H05B 3/145; H05B 3/36; B32B 2262/0284; B32B 2413/00; B32B 2262/103; B32B 2262/106; B32B 2255/02; B32B 2605/003; D10B 2505/122; H05B 2203/017; D03D 1/0005

(57) ABSTRACT

The invention provides a seat belt (10) for a motor vehicle comprising a webbing (12) that includes a tubular portion (22) in which at least one electric heating element (24) is accommodated. The invention further provides a method for manufacturing such seat belt (10).

### TECHNICAL FIELD

The invention relates to a seat belt for a motor vehicle. Furthermore, the invention relates to a method for manufacturing a seat belt for a motor vehicle.

### BACKGROUND

Seat belts for motor vehicles include a webbing that is usually made from a woven fabric, for example from PET. In general, a seat belt serves to fix a vehicle occupant on the vehicle seat, if the is vehicle strongly decelerated and corresponding forces act upon the vehicle occupant. The seat belt may further be part of a safety system which, inter alia, comprises a belt tensioner so that the seat belt, especially the webbing, is tensioned in case a crash or the like is imminent. This ensures the vehicle occupant to be fixed to the vehicle seat via the seat belt at an early stage.

Typically, the seat belt itself has no additional functions, however.

Moreover, for a conventional motor vehicle it is known that the passenger compartment is heated by means of the waste heat of the internal combustion engine so that the vehicle occupants are warmed via the atmosphere in the passenger compartment. In electric vehicles, on the other hand, the required heating capacity must be provided by the vehicle battery which additionally provides the electrical energy for operating the electric motor.

Based on the electric heating capacity, the available cruising range of the electric vehicle is reduced, however, when the heating is operating. Therefore, a heating system is desired which requires as little electric power as possible and still does not impair the occupants' comfort.

### SUMMARY

It is the object of the invention to provide a possibility of efficiently warming a vehicle occupant.

In accordance with the invention, the object is achieved by a seat belt for a vehicle comprising a webbing that includes a tubular portion in which at least one electric heating element is accommodated. In this respect, it is provided according to the invention to place the heat source or heating provided by the electric heating element closer to the vehicle occupant so that the vehicle occupant can be efficiently warmed. This is possible as, according to the invention, the air in the passenger compartment of the vehicle need not be warmed by the heating. Thus, the heating capacity required is considerably reduced, as the vehicle occupant is warmed directly through the seat belt, especially through the electric heating element accommodated in the tubular portion of the webbing.

In order to be able to control the heat distribution especially efficiently, there may be provided plural tubular portions in each of which at least one electric heating element is accommodated. The individual electric heating elements can be driven independently of each other so that a proper heat distribution can be adjusted.

The tubular portion extends at least over a segment of the webbing in the longitudinal direction of the webbing. This allows a desired portion of the webbing to have a defined heating profile. The tubular portion may extend over a section only or over the entire length of the webbing. Insofar, the heating element can also be provided to extend over a section or the entire length of the webbing.

If the tubular portion extends only over a segment of the webbing in the longitudinal direction of the webbing, i.e., over a section, the retractability can be correspondingly improved. In other words, the webbing then exhibits better retracting behavior.

Basically, the electric heating element can extend over the entire length of the tubular portion or over a segment of the tubular portion.

In general, this allows the electrical power being consumed to be utilized as efficiently as possible, if it is not necessary to heat the entire webbing, and especially areas which are not adjacent to the vehicle occupant's body.

Furthermore, the tubular portion substantially extends over the entire width of the webbing.

The tubular portion may be provided to be formed by a one-piece layer, for example by means of extrusion or by appropriate sewing.

In particular, the tubular portion thus is a tubular woven fabric.

It may further be provided that the webbing is double-layered in the area of the tubular portion and is single-layered in the area outside the tubular portion. A webbing of this type can be formed especially by a suitable weaving process by which especially even the peripheral area of the tubular portion is formed already during weaving. Consequently, the webbing is woven in one piece in such manufacturing method.

Furthermore, the webbing may be provided to be continuously manufactured as a tubular woven fabric, especially by a suitable weaving process.

The tubular portion may also be formed by two (separate) layers which are interconnected at the periphery. In this way, it is possible to fix the heating element at the desired position initially on one side and only then to close the tubular portion. In addition, the edge enables the heating element to be safely fixed within the webbing. Also, the heating element can initially be fixed by one layer which is then connected to the other layer to form the tubular portion. Equally, the heating element can initially be placed on one layer only, whereupon then the other layer is placed. When connecting the two layers at the periphery, the heating element can simultaneously be coupled to the webbing. Hence, basically a double-layer webbing may be provided.

In particular, at its end the tubular portion is converted into a double fabric.

The at least one layer of the webbing may be a fabric layer comprising especially PET.

The heating element comprises at least one carrier on which an electrically conductive heating material is disposed. The carrier serves to stabilize the heating element, especially when the heating element comprises a flexible heating material. A suitable carrier is especially a non-woven. This non-woven can be easily coupled to a heating material. Moreover, the non-woven can be easily connected to the webbing, especially to the layers.

The heating material can comprise at least one conductive fiber element and/or one conductive stranded element. The conductive fiber element may comprise, for example, a carbon fiber and/or a conductive filament. The conductive stranded element may be in the form of a metal strand, for example. The metal strand may especially be in the form of a copper strand and/or a steel strand which may include a copper coating. This is a substantially flexible heating material which can adapt to the shape of the webbing so that the webbing will not become too stiff. Moreover, proper heat transfer is thus enabled in a desired geometry.

The electrically conductive heating material may also be a coating of the carrier. In particular, the carrier is coated on both sides with the electrically conductive heating material so that the carrier includes, on each of its opposed sides, a coating serving as an electrically conductive heating material. Alternatively, the carrier may have a one-sided coating with the electrically conductive material. In addition, portions of the carrier may be coated on both sides and portions of the carrier may be coated on one side with the electrically conductive material. Moreover, the coating may also be partially applied to the carrier on one side and/or on both sides of, for example in loop shape.

The electrically conductive heating material is distributed especially evenly on the carrier so that a homogenous heat distribution without any hotspots or the like is obtained. For example, also a film or a film-type substance to which the electrically conductive heating material is fully or partially applied as a coating may be used as a carrier.

Moreover, a coating serving as an electrically conductive heating material is very thin so that it will hardly change the retracting behavior of the seat belt. The electrically conductive heating material therefore is little or not at all perceptible.

The heating material may be especially loop-shaped. This enables both ends of the heating material to be contacted at the same end of the heating element. Hence, the two free ends of the heating material are assigned to the same end of the heating element, as the heating material is disposed in loop shape. Insofar, only one electrical interface at which an electric contact is applied to the heating element has to be provided for the electric heating element. Accordingly, the manufacture of the seat belt comprising the integrated heating unit is facilitated.

The heating material may be provided to be arranged in the form of plural loops on the carrier. The free ends of the heating material arranged in plural loops are preferably assigned to the same end of the heating element so that, even in such embodiment, the contacting can be provided via one single electrical interface for the electric heating element. Accordingly, each of the individual loops can be provided to be separately contacted so that each loop-shaped heating material forms a separate heating circuit. For example, the electromagnetic environmental impact can be optimized by such arrangement and contacting.

For fixing the heating material on the carrier, said heating material may have been embroidered and/or applied by means of crochet galloon technique onto the carrier. This results in an especially simple and cost-efficient option of fixing and providing in advance the heating material on the carrier. In particular, the heating material itself is used as an embroidery and/or crochet material. The carrier serves to stabilize the electric heating element so that an appropriately flexible heating material can be used.

Further, the electric heating element may be a heating fabric. The heating fabric is then received by the tubular portion. The heating fabric comprises especially heating material that is interwoven so as to correspondingly form the heating fabric. The heating material is thus shaped to have appropriate inherent stability.

The electric heating element can be fixed, especially bonded and/or stitched, to the tubular portion. This makes sure that the electric heating element remains at the desired position and will not get out of place within the tubular portion. In a simple manner, the heating element is bonded to the tubular portion, especially to the inside thereof. Also, it can be sewn with the tubular portion, for example, when the tubular portion or, resp., the webbing per se is produced.

In order to protect the electric heating element against external influences such as sweat or water, at least areas of the electric heating element can be insulated. For this purpose, an insulated heating material, an insulating coating such as a resin, and/or a surrounding insulation may be provided. The electric heating element may also be laminated with an insulating film. Accordingly, the safety is increased as the electrically conductive material cannot be exposed to water or other liquids due to the insulation. Further, the insulation or, resp., the coating protects against mechanical impact such as abrasion. The insulated heating material may comprise, for example, at least one copper strand and/or one steel strand including a copper coating and/or one carbon fiber and/or one conductive filament including an enamel insulation. In addition, the insulated heating material may comprise a core yarn in which preferably an insulating layer is spun around the conductive fiber.

Especially, a thin water-repellant material is provided on each of the opposite sides of the electric heating element in the form of a heating fabric. The electric heating element in the form of a heating fabric is especially surrounded by said material.

Consequently, the material constitutes an insulation.

In particular, a carrier in the form of a film may simultaneously constitute the insulation, at least on one side, for a coating in the form of an electrically conductive heating material, especially when the coating in the form of an electrically conductive heating material is applied to only one side of the carrier. In order to obtain complete insulation, the carrier and the electrically conductive coating may be laminated with an insulating film or an insulating coating may be applied. Said additional coating is applied at least to the side of the coating in the form of an electrically conductive heating element which is not insulated by the carrier.

The seat belt may include an end fitting on which an electrical contact is applied to the electric heating element. An electrical contact is applied to the end side of the electric heating element in a simple manner, for which purpose the end fitting is basically suited, as typically the latter is not provided in the motion area of the vehicle occupants so that any inadvertent damaging can be effectively prevented. Moreover, further components of the seat belt which have a more complex design and less free construction space such as, e.g., the retractor can remain unchanged.

Furthermore, according to the invention, the object is achieved by a method for manufacturing a seat belt for a motor vehicle, wherein a webbing and at least one electric heating element are provided. Then the electric heating element is fastened to the webbing.

The afore-mentioned advantages are analogously resulting for the method, as here a seat belt comprising an electric heating system is provided which, when the vehicle occupant is wearing the seat belt, is in direct vicinity of the vehicle occupant so that the latter can be warmed more efficiently than in the case of heating the entire passenger compartment.

The webbing may include a tubular portion into which the electric heating element is introduced. Accordingly, the heating element is disposed inside the webbing so that it is accommodated in a protected manner. In addition, manipulation can be prevented.

It is further possible to form a tubular portion surrounding the electric heating element after the electric heating element has been fastened to the webbing. In this way, during the manufacturing process easy access of the desired position of the heating element inside the webbing is ensured. Only subsequently, viz. after fastening the heating element, is the tubular portion surrounding the electric heating element formed, thus allowing manufacture to be correspondingly facilitated.

For safely fixing the electric heating element inside the webbing, the electric heating element can be adhesively bonded to the webbing and/or sewn to the webbing. This can be done, for example, during the manufacturing process in a separate working step in which the heating element is introduced to and fixed within the tubular portion of the webbing. Alternatively, the heating element can be introduced, in a suitable manufacturing process, to the tubular portion directly during manufacture of the webbing, for example during weaving. In general, it is true that preferably no later work is required by those manufacturing methods.

Moreover, the electric heating element may comprise a carrier and a heating material which is embroidered onto the carrier and/or is applied by means of crochet galloon technique. This can ensure correct positioning of the heating material on the carrier. The carrier generally serves to stabilize the heating material.

In order to protect the electric heating element inside the webbing against external influences such as water and/or sweat, the heating element, preferably the heating material, can be coated and/or laminated with an insulating material during the method.

### BRIEF DESCRIPTION OF THE FIGURES

Further advantages and characteristics of the invention will be evident from the following description and the drawings which will be referred to, and wherein:

FIG. 1 shows a schematic view of a seat belt according to the invention comprising a webbing;

FIGS. 2a and 2b show schematic views of a tubular portion of the webbing of a seat belt according to the invention;

FIGS. 3a and 3b show schematic views of two variants of a heating element used in the seat belt according to the invention;

FIG. 4 shows a schematic sectional view of a webbing of a seat belt according to the invention in an exploded view;

FIG. 5 shows a schematic sectional view of another webbing of a seat belt according to the invention in an exploded view; and

FIG. 6 shows a schematic sectional view of another webbing of a seat belt according to the invention in an exploded view.

### DETAILED DESCRIPTION

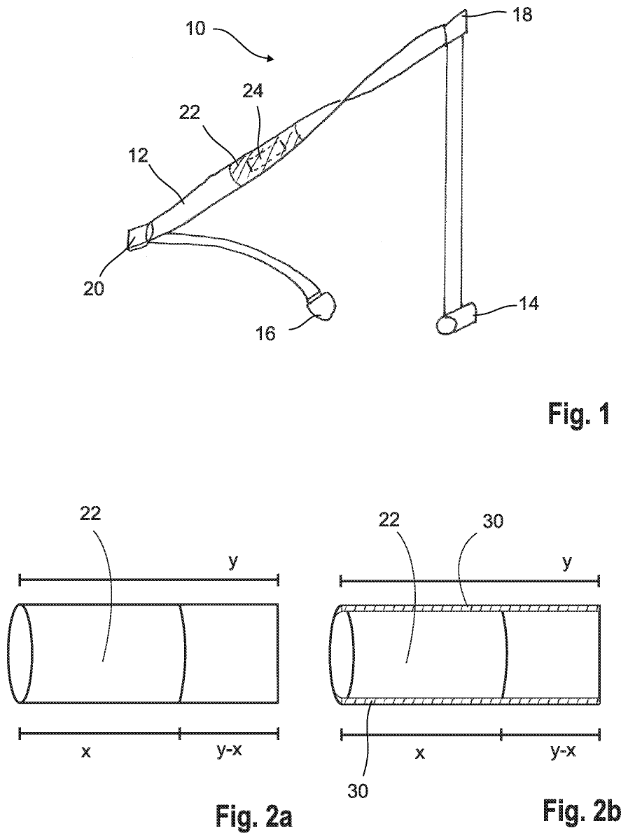

FIG. 1 illustrates a seat belt 10 for a motor vehicle comprising a webbing 12 a first end of which is assigned to a webbing retractor 14 and a second end of which is assigned to an end fitting 16.

Moreover, the seat belt 10 comprises a deflecting device 18 via which the webbing 12 is appropriately deflected.

In addition, a plug tongue 20 through which the webbing 12 is passed is movably arranged on the webbing 12.

The webbing 12 additionally includes a tubular portion 22 in which at least one electric heating element 24 is accommodated. The electric heating element 24 serves for the heating of a vehicle occupant who is wearing the seat belt 10, especially the webbing 12.

The electric heating element 24 can be easily contacted via the end fitting 16. Accordingly, the heating element 24 is passed, at least with its contacts, up to the end fitting 16. Thus, the contacts may extend through the webbing 12.

Equally, the heating element 24 may be embedded in the webbing 12, especially in the tubular portion 22.

The electric heating element 24 can extend over the entire tubular portion 22 or over a partial area only by which the heating area of the webbing 12 can, inter alia, be defined.

The tubular portion 22 extends at least over a partial area of the webbing 12, as is schematically shown in FIG. 1.

As an alternative, the tubular portion 22 can also extend over a longer or shorter area of the webbing 12 in the longitudinal direction of the webbing 12, especially over the entire length of the webbing 12.

The heating area can be appropriately adjusted via the length of the tubular portion 22 as well as the length of the electric heating element 24 within the tubular portion 22.

The tubular portion 22 may be formed by an integrally formed fabric portion that is combined at its longitudinal ends at the end so that after that a double-layer webbing 12 is resulting. This is evident from FIG. 2a.

Also, the tubular portion 22 may be formed by two separate layers 26, 28 the edges of which are connected, for example sewn, to each other. In FIG. 2b, the two sewn edges 30 are emphasized for clarification.

In sewing the edges 30, moreover the electric heating element 24 may have been fastened to the webbing 12, especially to the layers 26, 28.

Alternatively, the electric heating element 24 may have been fastened, especially sewn or bonded, initially to a first one of the two layers 26, 28, wherein subsequently the other layer 26, 28 is placed onto the first layer 26, 28 and the electric heating element 24 fastened thereto. Then the two layers 26, 28 can be connected to each other.

Likewise, the electric heating element 24 may be initially placed onto the first layer 26, 28 only, upon which then the other layer 26, 28 is placed. After that, the two layers 26, 28 are sewn to each other, with the electric heating element 24 being simultaneously coupled to the layers 26, 28 so that it is safely received within the tubular portion 24.

In each case, the electric heating element 24 is fastened to the webbing 12 in this way and is especially fixed on the tubular portion 22.

The at least one layer of the webbing 12 may be in the form of a fabric layer, and therefore the webbing 12 outside the tubular portion 22 corresponds to a double fabric.

Alternatively, the webbing 12 can be manufactured so that the webbing 12 outside the tubular portion 22 constitutes a single-layer fabric. Such webbing 12 can be produced, for example, by a suitable weaving process.

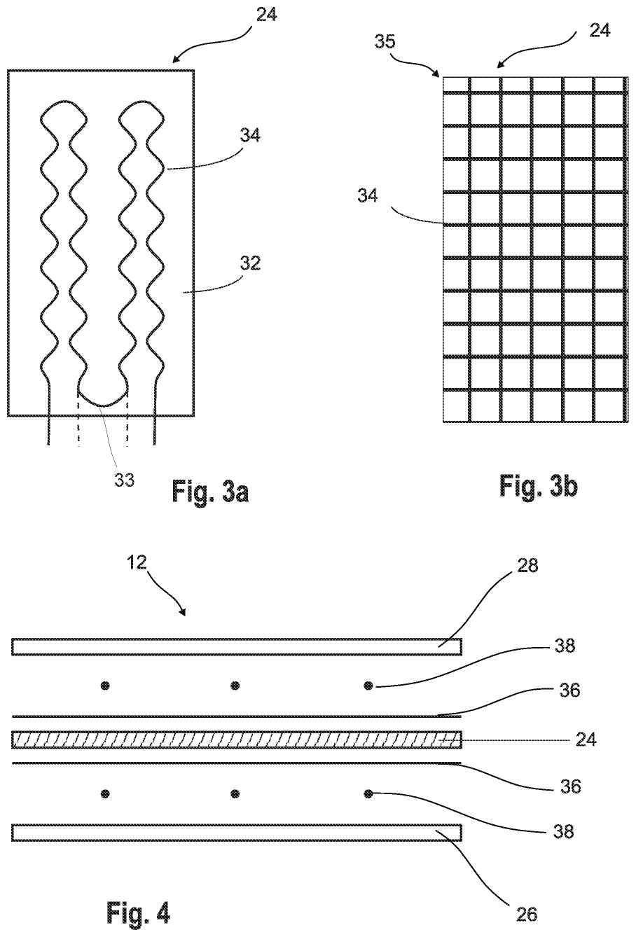

FIG. 3a illustrates that the electric heating element 24 comprises at least one carrier 32 and one electrically conductive heating material 34.

The carrier 32 may be a non-woven.

The heating material 34 may comprise at least one conductive fiber element and/or one conductive strand element, as shown in FIG. 3a. In particular, the conductive fiber element and/or a conductive strand element may be configured as a copper strand and/or as a steel strand including a copper coating and/or as a carbon fiber and/or as a conductive filament.

The heating material 34 can be arranged substantially in loop shape on the carrier 32 so that the free ends of the heating material 34 are assigned to the same end of the heating element 24. In this way, contacting of the heating material 34 and, resp., the heating element 24 is appropriately facilitated. The broken lines illustrate that the heating material 34 can further be arranged in plural separate loops on the carrier 32, wherein, in such embodiment, the connecting portion 33 of the heating material is omitted.

The heating material 34 can be generally fixed on the carrier 32, for example by embroidery and/or by means of crochet galloon technique. The heating material 34 may provide the embroidery or crochet material.

The heating material 34 may be arranged both on one side only or on both sides of the carrier 32.

As an alternative, the electric heating element 24 is a heating fabric 35 as shown in FIG. 3b. Hence, the electric heating element 24 may also consist of the heating fabric 35.

In the heating element 24 configured as a heating fabric 35 the respective heating material 34 is especially interwoven with itself to provide a certain stability so that no carrier material is required.

From FIG. 4 which illustrates a schematic sectional view of the webbing 12 of a seat belt 10, it becomes clear that the electric heating element 24 can be provided with an insulation 36, for example, to be protected against water and sweat, said insulation being, e.g., in the form of an insulating layer with which the heating element 24 can be laminated or coated.

Alternatively, the heating material 34 itself includes an insulating layer, for example by providing the heating material 34 with an enamel insulation.

Also, a separately formed insulation 36 surrounding the electric heating element 24 or the heating material 34 may be provided.

In general, the heating material 34 may comprise at least one conductive fiber element and/or one conductive stranded element such as a copper strand and/or a steel strand including a copper coating and/or a carbon fiber and/or a conductive filament.

Further, it is visible from FIG. 4 that the electric heating element 24 is adhesively bonded to the webbing 12 via corresponding adhesive points 38, with the heating element 24 including the corresponding insulation 36.

In particular, via the adhesive points 38 the electric heating element 24 is bonded to the tubular portion 22 formed by the two layers 26, 28 in the shown embodiment.

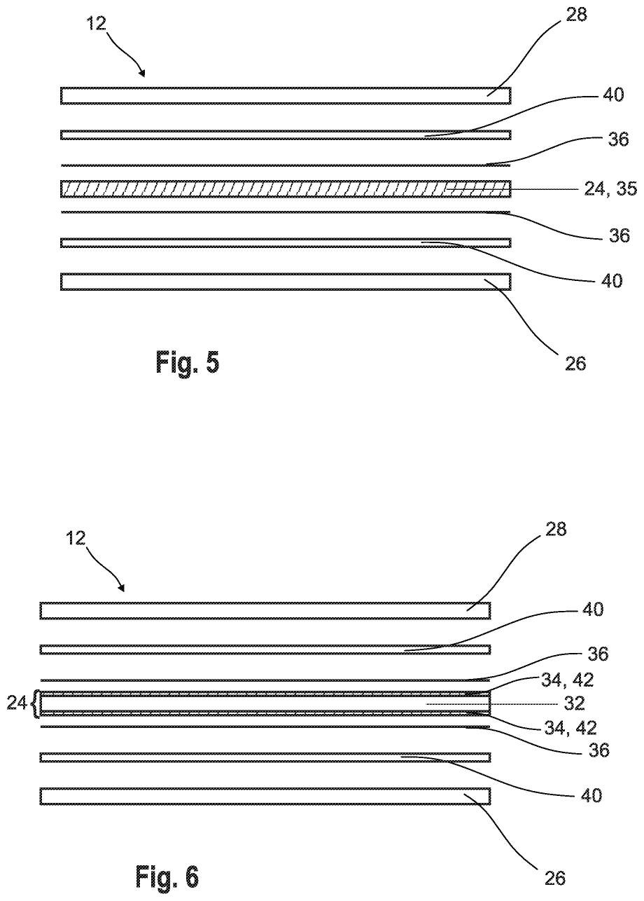

Instead of the adhesive points 38, there may as well be provided an adhesive layer 40, as shown in FIG. 5.

Furthermore, adhesive points 38 and/or an adhesive layer 40 may be provided on one side only.

The adhesive layer 40 may be a thermoplastic adhesive layer or a thermoplastic adhesive film such as, e.g., a thermoplastic adhesive web.

In the embodiment shown in FIG. 5, the electric heating element 24 is configured as the heating fabric 35 which is provided with the insulation 36 on each of its sides assigned to the layers 26, 28.

Between each of the respective insulation 36 and the assigned layer 26, 28, the adhesive layer 40 is further provided.

FIG. 6 describes another embodiment in which the electric heating element 24 includes, as already described before with respect to FIG. 3a, the carrier 32 on which the electrically conductive material 34 is arranged.

In the shown embodiment, the electrically conductive material 34 is applied as a coating 42. Insofar, the carrier 32 is coated on both sides with the electrically conductive heating material 34. Alternatively (not shown), the carrier 32 may be coated with the electrically conductive heating material 32 on one side only. Further (not shown), portions of the carrier 32 may be coated on one side and portions of the carrier 32 may be coated on both sides with the electrically conductive heating material 32.

The coating 42 is very thin so that the retracting behavior of the seat belt 10 will little vary or, resp., will not vary.

The electric heating element 24 is provided, for example coated or laminated, with the insulation 36, wherein the insulated electric heating element 24 is fastened to the layers 26, 28 by the adhesive layer 40 in the shown embodiment.

The insulated electric heating element 24 may further be fastened, irrespective of whether it is coated on one side and/or on both sides with the electrically conductive heating material 32, to only one of the layers 26 or 28 on one side only by the adhesive layer 40.

Instead of the adhesive layer 40, also plural adhesive points may be provided, as already described before.

That means that the individual layers and coats which, in the FIGS. 4 to 6, are shown separate from each other for reasons of better clarity are directly adjacent to each other.

In general, the manufacture of the seat belt 10 can be carried out in a simple manner in a calender, a pressing machine or a continuous press, wherein the electric heating element 24, especially the heating fabric 35, is permanently fixed, for example adhesively bonded, within the tubular portion 22 by heat supply and pressure.

Alternatively, the electric heating element 24, especially the heating fabric 35 and/or the carrier 32 coated with the electrically conductive material 34, are sewn within the tubular portion 22, as already explained before.

The electric heating element 24 fastened within the tubular portion 22 helps implement an electric heating in a simple and cost-efficient manner in the seat belt 10, namely using the seat belt 10 in which the electric heating element 24 is integrated that acts as a heating system.

1-15. (canceled)

16. A seat belt (10) for a motor vehicle, comprising a webbing (12) that includes a tubular portion (22) in which at least one electric heating element (24) is accommodated.

17. The seat belt according to claim 16, wherein the tubular portion (22) extends at least over a partial area of the webbing (12) in the longitudinal direction of the webbing (12).

18. The seat belt according to claim 16, wherein the tubular portion (22) is formed by two layers (26, 28) which are connected to each other at the periphery.

19. The seat belt according to claim 16, wherein the electric heating element (24) comprises at least one carrier (32) on which an electrically conductive heating material (34) is disposed, especially wherein the carrier (32) comprises a non-woven and/or the heating material (34) comprises at least one copper strand and/or one carbon fiber.

20. The seat belt according to claim 19, wherein the heating material (34) has been embroidered and/or applied by means of crochet galloon technique onto the carrier (32).

21. The seat belt according to claim 16, wherein the electric heating element (24) is a heating fabric (35).

22. The seat belt according to claim 16, wherein the electric heating element (24) is fixed, especially bonded and/or sewn to the tubular portion (22).

23. The seat belt according to claim 16, wherein the electric heating element (24) is insulated at least in areas, especially wherein an insulated heating material (34), an insulating coating and/or a surrounding insulation is/are provided.

24. The seat belt (10) according to claim 16, wherein the seat belt (10) includes an end fitting (16) on which the electric heating element (24) is electrically contacted.

25. A method for manufacturing a seat belt (10) for a motor vehicle, comprising the steps of:
providing a webbing (12) and at least one electric heating element (24), and
fastening the electric heating element (24) to the webbing (12).

26. The method according to claim 25, wherein the webbing (12) includes a tubular portion (22) into which the electric heating element (24) is introduced.

27. The method according to claim 25, wherein a tubular portion (22) surrounding the electric heating element (24) is formed after the electric heating element (24) has been fastened to the webbing (12).

28. The method according to claim 25, wherein the electric heating element (24) is adhesively bonded to the webbing (12) and/or is sewn to the webbing (12).

29. The method according to claim 25, wherein the electric heating element (24) comprises a carrier (32) and a heating material (34) that is embroidered and/or applied by means of crochet galloon technique to the carrier (32).

30. The method according to claim 25, wherein the electric heating element (24) is insulated, especially wherein the electric heating element (24), preferably the heating material (22), is coated and/or laminated with an insulating material.
